(19) United States
(12) Patent Application Publication
(10) Pub. No.: US 2003/0151208 A1
(43) Pub. Date: Aug. 14, 2003

(54) Seal element of a face seal device

(75) Inventors: Michael Riedl, Eurasburg (DE); Wolfang Ries, Eschenlohe (DE); Reinhard Svejkovsky, Geretsried (DE)

Correspondence Address: SUGHRUE MION, PLLC, Suite 800, 2100 Pennsylvania Avenue, N.W., Washington, DC, 20037-3213, US

(73) Assignee: BURGMANN DICHTUNGSWERKE

(21) Appl. No.: 10/377,669

(22) Filed: Mar. 4, 2003

Related U.S. Application Data
(63) Continuation of application No. PCT/EP02/03408, filed on Mar. 27, 2002.

(30) Foreign Application Priority Data
May 11, 2001 (DE) 201 07 960.7

(51) Int. Cl. F16J 15/34

(52) U.S. Cl. 277/370

(57) ABSTRACT

A seal element of a face seal device for sealing a rotary component relative to a stationary component, includes a pair of mounting portions spaced apart from each other and a bellows portion connected with and extending between the mounting portions. One of the mounting portions serves for non-rotational mounting on the rotary component and the other for mounting a seal ring thereon. At least the surfaces of the mounting and bellows portions which are subjected to a medium which is to be sealed are formed of a synthetic material essentially resistant to the medium. The one mounting portion includes at least a single screw bore essentially radially extending therethrough. A screw pin made of a ceramic material is inserted in the screw bore for clamping the mounting portion relative to the rotary component.

The present application is a Continuation of the international patent application No. PCT/EP02/03408, filed on Mar. 27, 2002 with claim of a priority of May 11, 2001 of the German utility model application 20107960.7, which is incorporated into this application by reference.

### FIELD OF AND BACKGROUND OF THE INVENTION

The invention relates to a seal element of a face seal device and more particular to a seal element which enables design of a face seal device having particular, but not exclusive, utility for use in connection with aggressive media.

A seal element is known from WO 99/53227 which includes a central bellows portion, this, accordingly, being axially and radially movable and being bounded at each end by stiff mounting portions. The seal element may be formed entirely from a synthetic material which is resistant to the medium that is to be sealed. Although uncomplicated face seal device which can be externally pressurized, for use with aggressive media may be made with the aid of this seal element, the problem could not as yet be satisfactorily solved as to how mounting of the seal element on the relevant component of the equipment, in which it was intended that the face seal device should be employed, could be effected without affecting the chemical resistance of the arrangement and/or the operational reliability thereof. Despite being comparatively complicated and thus making assembly and maintenance of the devices more complicated, the measures proposed in this connection in the aforesaid document frequently could not ensure a permanent secure position of the seal element on the relevant component e.g. the drive shaft of a pump impeller.

### OBJECTS OF THE INVENTION

An object of the invention is to provide an improved seal element for a face seal device suitable for use with aggressive media. Another object of the invention is to provide a seal element which can easily be assemblied and has improved operational reliability whilst at least having a similar chemical resistance to the medium as that of a prior seal element.

### SUMMARY OF THE INVENTION

These and other objects are solved in accordance with the present invention by a seal element of a face seal device for sealing a rotary component relative to a stationary component, including a pair of mounting portions spaced apart from each other and a bellows portion connected with and extending between the mounting portions, one of said mounting portions serving for non-rotational mounting on the rotary component and the other for mounting a seal ring thereon, at least the surfaces of said mounting and bellows portions subjected to a medium which is to be sealed being formed from a synthetic material essentially resistant to the medium, said one mounting portion including at least a single screw bore essentially radially extending therethrough, wherein a screw pin made of a ceramic material is inserted in said screw bore for clamping the mounting portion relative to the rotary component.

With the aid of these measures, not only the chemical resistance of the seal element itself is unrestrictedly ensured, but so too is that of the area at which the seal element is mounted to rotary component of the equipment on which the face seal device is provided. In particular, the seal element has no metallic parts that are subjected to the medium. Although the screw pin is made of ceramic material this prevents a skilled person during an assembly operation not from proceeding in a manner that is basically known to him in that he needs but to fasten the screw pin for obtaining an effective reliable connection between the seal element and the rotary component. Furthermore, a substantially improved operational reliability of the seal element is thereby achieved even though this may consist entirely of a synthetic material. Namely, as a result of the hardness of the ceramic material of the screw pin not only a common frictional clamping engagement of the seal element with the rotary component of the equipment can be obtained, but also an interlocking and thus permanent reliable connection can be obtained but, in accordance with a further embodiment of the invention, the screw pin can be provided with means e.g. in the form of an annular cutting edge, which is able to cut into the surface of the component. Consequently, by virtue of the combination of an extremely hard ceramic material and a synthetic material that is “soft” in comparison with a steel material, the long standing problems of seal elements of the type in question can be overcome in a surprisingly simple manner.

### BRIEF DESCRIPTION OF THE DRAWING

The invention will be explained in more detail hereinafter with reference to the drawing and an embodiment thereof. In the drawings:

FIG. 1 is a longitudinal fragmentary sectional view of a face seal device including a seal element in accordance with the present invention in combination with its use in a pump,

FIG. 2 is a sectional detailed view of the seal element of FIG. 1 illustrating means for fixing the seal element to a component in accordance with an embodiment of the invention, and

FIG. 3 is a view similar to that of FIG. 2 of the seal element of FIG. 1 illustrating means for fixing the seal element to a component in accordance with a another embodiment of the invention.

### DETAILED DESCRIPTION OF A PREFERRED EMBODIMENT

Although the invention is shown in connection with the sealing of the drive shaft of a pump impeller relative to a pump casing, it should be understood that the invention is not restricted to this field of use but can always be utilised to advantage if there is a need to effectively seal media, and especially those of a chemically aggressive kind such as acids or caustic solutions, relative to the environment by means of a face seal device of simple construction.

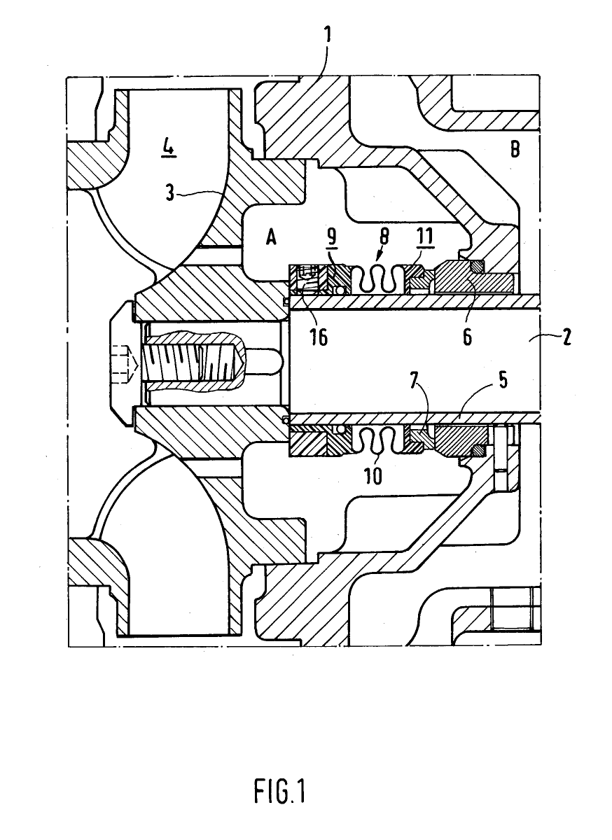

In FIG. 1, a casing of the pump bears the reference number 1, a drive shaft the reference number 2 and a pump impeller attached to the drive shaft the reference number 3. The pump impeller 3 rotates in a pumping chamber 4. A sleeve 5, upon which a face seal device including a seal element in accordance with the present invention is disposed, is placed on the shaft 2. The face seal device comprises a pair of seal rings, namely a seal ring 6 held in non-rotational manner on the casing 1 and a rotating seal ring 7 for common rotation with the drive shaft 2, which co-operates with the non-rotating seal ring 6. In operation, a gap is formed between the facing seal faces of the seal rings 6, 7 for sealing a space A peripherally outward of the face seal device from a space B in a fluid communication with the inner peripheral portions of the face seal device. The medium being pumped is applied to the outer peripheral space A.

The rotating seal ring 7 is held by a seal element which bears the general reference number 8. The seal element 8 comprises a bellows portion 10 to which is connected at each end a mounting portion 9 or 11, respectively. One of the mounting portions 9, 11, namely the left-hand mounting portion 9 in FIG. 1, serves for fixing the seal element 8 in non-rotational manner relative to the drive shaft 2, whilst the other, the right hand mounting portion 11 in FIG. 1, serves as a carrier for the rotating seal ring 7. Attachment of the seal ring 7 to the mounting portion 11 is preferably effected by means of a press fit e.g. a shrink-on fit.

The bellows portion 10 may be constructed in various manners, provided that it produces a resilient connection between the mounting portions 9, 11 which are stiffer than the bellows portion 10 due to the shape thereof. The mounting portions 9, 11 can thus move relative to one another in the axial and radial directions. Furthermore, the bellows portion 10 applies an axial bias force to the rotating seal ring 7 for urging the seal ring 7 against the stationary seal ring 6. The bellows portion 10 preferably has a snakelike cross-sectional configuration so as to promote its resilient properties.

The seal element 8, consisting of the bellows portion 10 and the end mounting portions 9, 11, is constructed in such a manner that it is resistant to the medium that is to be sealed. For this reason, the seal element 8 is preferably formed from a chemically resistant synthetic material or at least the surface of the seal element 8 is coated with such a material. Although other synthetic materials may be suitable, a material from the group of materials including polyetheretherketone (PEEK) and ethylene-chlorotrifluoro-copolymer (ECTFE) is preferably used. PEEK is available under the trade name TECAPEEK from the company Ensinger GmbH & Co., D-93413 Cham, and ECTFE is obtainable under the trade name HALAR from the company Green, Tweed & Co., Kulpsville/U.S.A., Pa. Each of these synthetic materials has a high resistance to a plurality of caustic solutions and acids and is thermally resistant up to approximately 250° C. (PEEK) or 160° C. (ECTFE), respectively.

A further advantage of PEEK and ECTFE is in their excellent resilient properties even at high temperatures. A bellows portion 10 made of these materials is therefore suitable for applying a previously mentioned bias force without the need for providing separate biasing means e.g. in the form of a bias spring means. If greater demands are made in the light of the pressures that are to be sealed, the central bellows portion 10 may comprise a metallic part e.g. of a spring steel which is embedded in the synthetic material and is connected in a suitable fluid-tight manner to the mounting portions 9, 11. The mounting portions 9, 11 may be separate moulded parts of the above mentioned synthetic materials.

Furthermore, the synthetic material for the mounting portions 9, 11 and the intermediate bellows portion 10 may be reinforced in suitable manner e.g. by SiC fibres, glass fibres, ceramic fibres or graphite fibres, i.e. these portion may be made of a fibre reinforced composite material.

The seal ring 7 may consist of any suitable material that is resistant to chemically aggressive media, such as, for example, silicon carbide, a ceramic sintered material such as aluminium oxide, a carbon material or the like. The seal ring 7 may be a separate component which is attached to the appertaining mounting portion 11 of the seal element 8 as previously described or it may be an integral component of the mounting portion 11, in that the seal ring 7 is e.g. sintered on the mounting portion 11. Basically, the previously described construction of the seal element is known from the WO document mentioned hereinabove. Reference may therefore be made thereto in respect of further details.

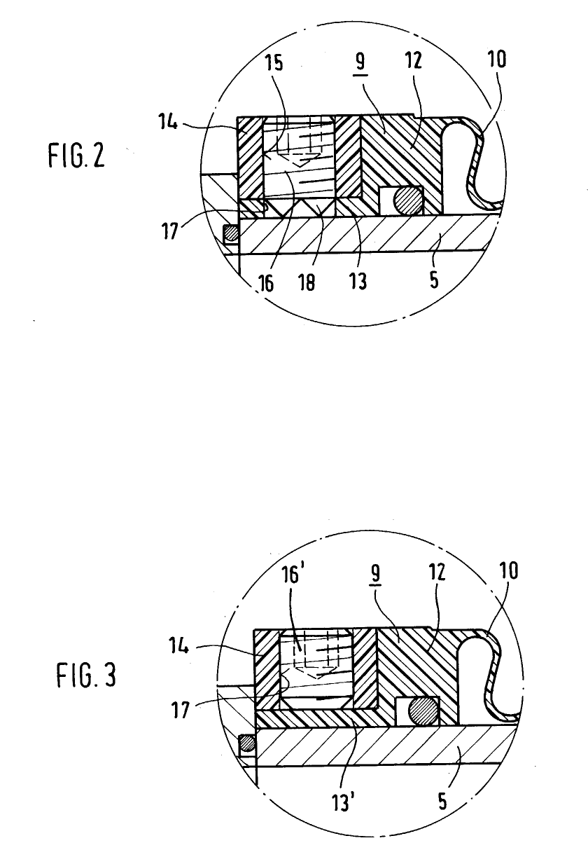

FIGS. 2 and 3 show embodiments of means for fixing the mounting portion 9 with respect to the drive shaft 2 or the sleeve 5. A feature common to both embodiments is a tubular elastic lug portion 13 provided on a base part 12 of the mounting portion 9 and projects axially from the base part 12. The lug portion 13 has a boring having an internal dimension that matches the outer dimension of the sleeve 5 so that the lug portion 13 can closely surround the sleeve 5. The tubular lug portion 13 preferably consists of the same material as that of the mounting portion 9 and is preferably integral therewith.

A mounting ring 14 having a radially extending screw bore 15, or several peripherally distributed such bores, is seated on the outer periphery of the tubular lug portion 13. A screw pin 16 can be screwed into said bore 15. The mounting ring 14 likewise consists of a suitable chemically and thermally resistant synthetic material which may correspond to that of the mounting portion 9.

In accordance with the invention, the screw pin 16 is formed from a ceramic material having at least a similar or preferably better chemical resistance to aggressive substances such as acids or alkaline solutions than that of the synthetic material which is otherwise envisaged for the seal element. A preferred ceramic material for the screw pin 16 is zirconium oxide or aluminium oxide. Other suitable ceramic materials could likewise be utilised. A preferred method of forming a screw pin of ceramic material is by press-moulding which is basically known to a skilled person so that a more detailed description thereof is not necessary.

A further advantageous property of the ceramic material is the significantly greater hardness thereof in comparison not only with the synthetic material the seal element is made of, but also in comparison with a metallic material such as steel from which the drive shaft 2 or the sleeve 5 may be formed.

In the embodiment of FIG. 2, the screw pin 16 can come into direct engagement with the surface of the sleeve 5, in that a bore or recess 17 is provided in the tubular lug portion 13 in aligned relationship with the threaded boring 15, through which the screw pin 16 can extend. The end face of the screw pin 16 facing the sleeve 5 may comprise means e.g. in the form of an annular cutting edge 18 which can enter or dig into the surface of the sleeve 5 to a small extent due to the hardness of the ceramic material. Reference may be made to the German Industrial Standard DIN 916 in regard to a suitable construction of an annular cutting edge 18. Both of a frictional and an interlocking rigid connection between the screw pin 16 and the sleeve 5 can be obtained in this manner.

FIG. 3 shows an embodiment which is designed such that the screw pin 16 can exert a radial clamping force on local portions of the tubular lug portion 13 so that the latter will be urged against the surface of the sleeve 5 in order to produce a clamped connection between the lug portion 13 and the sleeve 5. The end face of the screw pin 16 facing the lug portion 13 is preferably plane in this case. This embodiment produces a connection between the seal element 8 and the sleeve 5 such that the rotary motion of the drive shaft 2 and any existing axial thrusts will be conveyed to the seal ring 7 without damaging the surface of the sleeve 5.

The seal element in accordance with the present invention may be provided either together with the face seal device, or, as a separate component which can be mounted subsequently. The assembly dimensions are preferably such that a face seal device, to which the medium being sealed is applied externally, can be obtained which is suitable for narrow standard mounting spaces. In the previously described embodiments of the invention, the screw pin of ceramic material is screwed into screw bores in a mounting ring. The mounting ring and the tubular lug portion co-operating therewith could also be dispensed with if so desired, in that the screw pin could be screwed directly into a screw bore formed in the base part of the mounting portion.

The above description of embodiments of the invention has been given by way of example. From the disclosure given, those skilled in the art will not only understand the present invention and the attendant advantages, but will also find apparent various changes and modifications to the structures disclosed. It is sought, therefore, to cover all such changes and modifications as fall within the spirit and scope of the invention, as defined by the appended claims, and equivalents thereof.

What is claimed is:

1. A seal element of a face seal device for sealing a rotary component relative to a stationary component, including a pair of mounting portions spaced apart from each other and a bellows portion connected with and extending between the mounting portions, one of said mounting portions serving for non-rotational mounting on the rotary component and the other for mounting a seal ring thereon, at least the surfaces of said mounting and bellows portions subjected to a medium which is to be sealed being formed from a synthetic material essentially resistant to the medium, said one mounting portion including at least a single screw bore essentially radially extending therethrough, wherein a screw pin made of a ceramic material is inserted in said screw bore for clamping the mounting portion relative to the rotary component.

2. The seal element according to claim 1, wherein the screw pin comprises cutting means at an end face thereof providing an interlocking engagement with a surface of the rotary component.

3. The seal element according to claim 1, wherein that said one mounting portion comprises a lug portion underlaying the screw bore and the screw pin.

4. The seal element according to claim 1, wherein the screw bore and the screw pin are provided in a mounting ring made of said synthetic material and provided on said one mounting portion (9).

5. The seal element according to claim 1, wherein said mounting portions are formed entirely of said synthetic material.

6. The seal element according to claim 1, wherein said mounting portions and said bellows portion are formed entirely of said synthetic material.

7. The seal element according to claim 1, wherein that said synthetic material comprises PEEK.

8. The seal element according to claim 1, wherein that said synthetic material comprises ECTFE.
